(19) United States
(12) Patent Application Publication
(10) Pub. No.: US 2018/0320775 A1
(43) Pub. Date: Nov. 8, 2018

(54) Actuator Gearbox

(71) Applicant: Johnson Electric S.A., Murten (CH)

(72) Inventors: Harry Hang Fung CHANG, Hong Kong (CN); Wei Xing MAO, Shenzhen (CN); Yong Jun YANG, Shenzhen (CN); Ming YANG, Shenzhen (CN)

(21) Appl. No.: 16/026,453

(22) Filed: Jul. 3, 2018

Related U.S. Application Data
(63) Continuation of application No. 15/184,152, filed on Jun. 16, 2016.

(30) Foreign Application Priority Data
Jun. 19, 2015 (CN) 201510345657.6

(51) Int. Cl. F16H 57/039; E05F 15/697; F16H 57/031; F16H 1/16; F16H 57/027

(52) U.S. Cl. CPC F16H 57/039; E05F 15/697; F16H 57/031; F16H 2057/0213; F16H 1/16; F16H 57/027

(57) ABSTRACT

An actuator includes a motor and a gearbox connected with the motor. The gearbox has a lower housing, a gear received in the lower housing, and a cover disposed at one end of the lower housing. The lower housing has a support shaft supporting the gear for rotation relative to the lower housing. The support shaft is hollow. A core shaft is inserted into the support shaft. The core shaft is made of a metal material and the support shaft is made of a plastic material.

### CROSS REFERENCE TO RELATED APPLICATIONS

This non-provisional patent application is a continuation of co-pending application Ser. No. 15/184,152 filed on 16 Jun. 2016, for which priority is claimed under 35 U.S.C. § 120, and this application claims priority of Patent Application No. 201510345657.6 filed in The People's Republic of China on Jun. 19, 2015, the entire contents of which are hereby incorporated by reference.

### FIELD OF THE INVENTION

The present invention relates to an actuator, also known as a drive apparatus, and in particular to a gearbox for an actuator.

### BACKGROUND OF THE INVENTION

Existing actuators, such as the driving apparatus for car window lift systems, typically include a motor and a gearbox. The gearbox usually includes a transmission mechanism such as worm and worm gear. A drive gear is rotatably attached around a fixed shaft of the gearbox. An output shaft of the motor is meshed with the transmission mechanism. Upon power-on, the motor drives the transmission mechanism to rotate about the fixed shaft to drive a load. In order to ensure the stable connection between the transmission mechanism and the load, the fixed shaft is usually a metal shaft with high strength to make sure that the shaft does not deform or bend under load, affecting the stability of the connection. However, on the one hand, the metal shaft has a high material cost. On the other hand, after being initially shaped, the metal shaft needs further mechanical machining to form a sufficiently smooth surface to reduce the friction with the transmission mechanism. Therefore, the use of the metal shaft increases the overall cost of the gearbox.

### SUMMARY OF THE INVENTION

Hence there is a desire for an actuator gearbox which has a low cost and provides a stable output.

Accordingly, in one aspect thereof, the present invention provides an actuator gearbox comprising: a lower housing comprising a support shaft, the support shaft being hollow and made of a plastic material; a gear received in the lower housing and supported by the support shaft for rotation relative to the lower housing; a cover disposed at one end of the lower housing; and a core shaft inserted into the support shaft, the core shaft being made of a metal material.

Preferably, the support shaft and the lower housing are integrally formed by injection molding.

Preferably, a center hole is formed in the support shaft, and the core shaft is an interference-fit in the center hole of the support shaft.

Preferably, the center hole is a blind hole with one end closed and the other end opened.

Preferably, at least a portion of an outer surface of the core shaft and an inner wall surface of the center hole form a gap there between.

Preferably, the center hole is a round hole, and at least a portion of the outer surface of the core shaft is formed with knurls.

Alternatively, the gap between the core shaft and the center hole is formed by a ventilation groove extending axially along the inner wall surface of the center hole.

Preferably, a ratio of a width of an opening of the ventilation groove in the center hole and a diameter of the center hole ranges from 0.1 to 0.5.

Preferably, the core shaft is made of steel.

Preferably, a ratio of a diameter of the core shaft to a diameter of the support shaft ranges from 0.1 to 0.75.

According to a second aspect, the present invention provides an actuator comprising: a motor; and a gearbox connected with the motor, the gearbox comprising: a lower housing comprising a support shaft, the support shaft being hollow and made of a plastic material; a gear received in the lower housing and supported on the support shaft for rotation relative to the lower housing; a cover disposed at one end of the lower housing; and a core shaft inserted into the support shaft, the core shaft being made of a metal material.

In comparison with the prior art, the support shaft of the gearbox of the present invention is made of plastic, which has a low cost and can be easily formed. In addition, the core shaft made of metal material is inserted into the support shaft, which ensures the strength of the whole shaft and maintains the stability of the connection while effectively reducing the cost.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a perspective assembled view of an actuator in accordance with a first embodiment of the present invention.

FIG. 2 is a sectional view of the actuator of FIG. 1 taken along plane II-II.

FIG. 3 is a plan sectional view of the actuator of FIG. 1.

FIG. 4 is a partially exploded view of the actuator of FIG. 1.

FIG. 5 illustrates a core shaft of the actuator of FIG. 4.

FIG. 6 illustrates a lower housing of a gearbox of an actuator in according with a second embodiment of the present invention.

FIG. 7 is a plan view from below of the housing of FIG. 6.

FIG. 8 is a partially enlarged view of a framed portion VIII of FIG. 7.

FIG. 9 is a sectional view of the housing of FIG. 7.

### DETAILED DESCRIPTION OF THE PREFERRED EMBODIMENTS

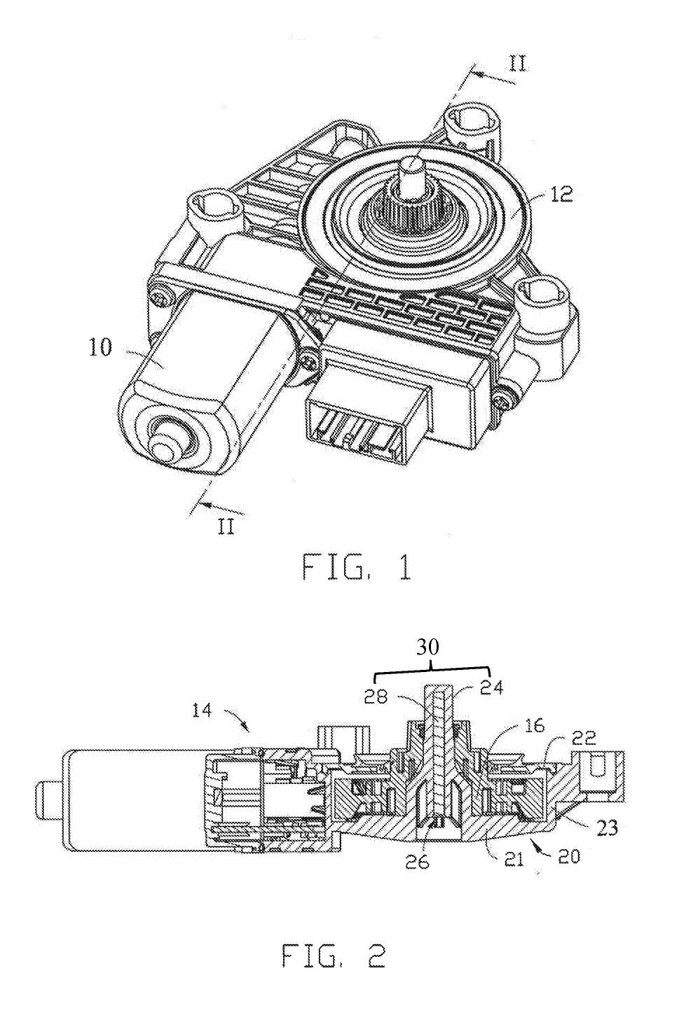

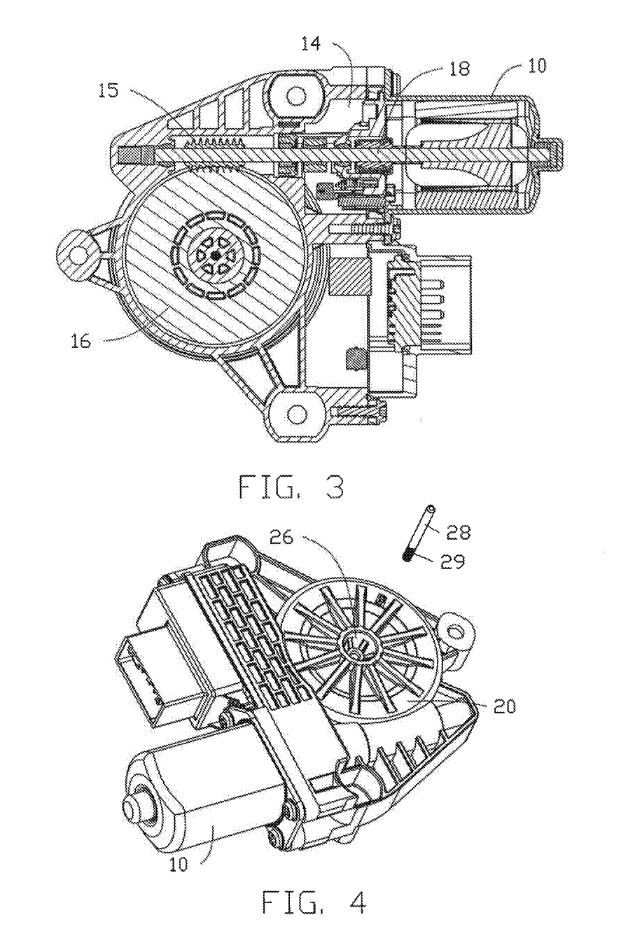

Referring to FIG. 1 to FIG. 5, a drive apparatus in accordance with one embodiment of the present invention includes a motor 10 and a gearbox 12 connected to the motor 10. The gearbox 12 includes an outer housing 14, and a transmission mechanism rotatably received in the outer housing 14. The transmission mechanism may be a gear transmission mechanism, a worm-gear transmission mechanism, a belt-wheel transmission mechanism, a planetary gear transmission mechanism, or the like. In this application, the transmission mechanism includes a worm 15 and a worm gear 16. The motor 10 includes a rotary shaft 18 for outputting a torque. The worm 15 is fixed on the rotary shaft 18. The rotary shaft 18 together with the worm 15 extends into the outer housing 14 and is engaged with the worm gear 16.

The outer housing 14 includes a lower housing 20 and an end cover 22 connected with the lower housing 20. The lower housing 20 is a cylindrical structure with an open end. When viewed from the aspect illustrated in FIG. 2, a top end of the lower housing 20 is open, and the end cover 22 closes the open end of the lower housing 20. The lower housing 20 includes a bottom wall 21 and a sidewall 23 extending from a periphery of the bottom wall 21 to the end cover 22. A center of the bottom wall 21 is raised axially toward the end cover 22 to form a support shaft 24. The worm gear 16 is attached around the support shaft 24 for rotation relative to the support shaft 24 under the driving of the worm 15. In this embodiment, a top end of the support shaft 24 extends through the end cover 22 and out of the outer housing 14. Preferably, the support shaft 24 is made of a plastic material, which is integrally formed with the lower housing 20 by injection molding. The support shaft 24 is hollow with a center hole 26, and a core shaft 28 disposed in the center hole 26. Preferably, the core shaft 28 is made of a metal material such as a high hardness material, e.g. carbon steel, which has a hardness far greater than that of the support shaft 24 formed of plastic. The core shaft 28 is inserted into the support shaft 24 to enhance the strength of the support shaft 24, thus effectively supporting the rotation of the worm gear 16.

In this embodiment, the center hole 26 is a blind hole with an opened bottom end and a closed top end. The core shaft 28 is cylindrical and elongated in shape, which is inserted into the center hole 26 from the bottom opening of the center hole 26. Preferably, a diameter of the core shaft 28 may be substantially equal to or slightly greater than a hole diameter of the center hole 26. Because the support shaft 24 is made of plastic, it produces a certain amount of deformation during the course of inserting the core shaft 28. After the core shaft 28 is inserted, the core shaft and the support shaft 24 form an interference-fit there between and are thereby fixed together. Because the core shaft 28 is made of metal, the core shaft 28 and the support shaft 24 together form an axle 30 with high strength which can withstand the loading applied by the worm gear without being deformed. Preferably, a ratio of a diameter of the core shaft 28 to a diameter of the support shaft 24 ranges from 0.1 to 0.75.

Referring to FIG. 5, in this embodiment, an outer surface of one end of the core shaft 28 is formed with knurls 29. In this embodiment, the knurls 29 are embossed ribs which are arranged at locations spaced in a circumferential direction. In other embodiments, the knurls 29 may be spiral-shaped or in other patterns. During the course of pressing the core shaft 28 into the center hole 26, gaps are formed at some regions between the core shaft 28 and an inner wall surface of the center hole 26 because of the knurls 29 formed on the core shaft 28, which can avoid the failure of pressing the core shaft 28 into a predetermined position due to air trapped at the top end of the core shaft 28.

Because the plastic support shaft 24 is integrally formed with the lower housing 20, the support shaft 24, upon being formed, can provide a smooth outer surface for supporting the worm gear 26 for rotation without further mechanic machining. In addition, the metal core shaft 28 is inserted into the support shaft 24, which can effectively enhance the strength of the support shaft 24 and prevent the support shaft 24 from being deformed under the torque applied to the worm gear 26. The forming of the entire support shaft structure of the present invention is simplified, more convenient and faster when compared with the conventional metal shaft. In addition, the material of the shaft support 24 is plastic, which has a lower material cost than metal and can thus reduce cost. Furthermore, the metal core shaft 28 is inserted into the center of the support shaft 24, which ensures that the entire support shaft structure have an enhanced strength and will not be deformed during rotation of the worm gear, and ensures stability of the transmission or connection to the load and reduced noise as well.

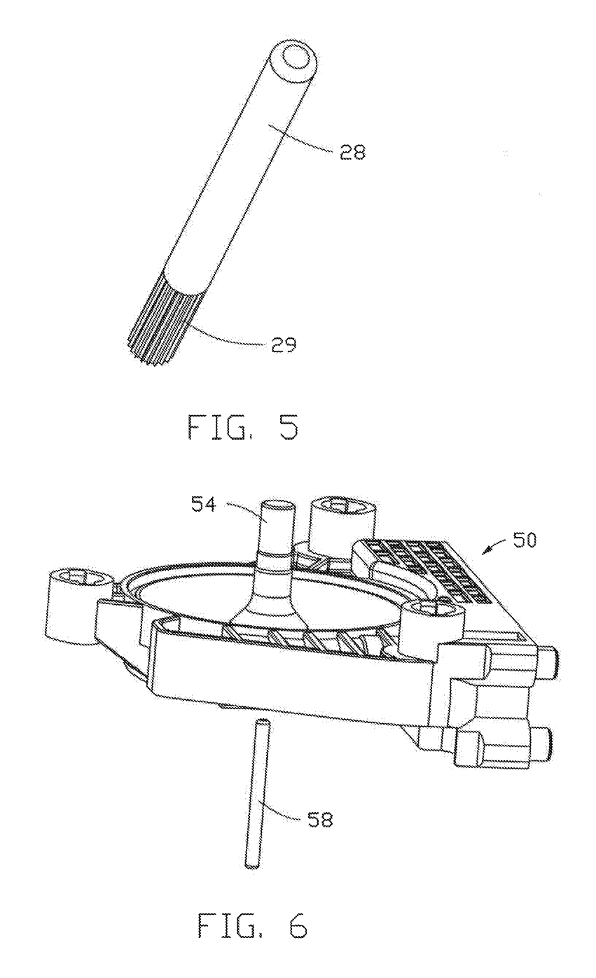

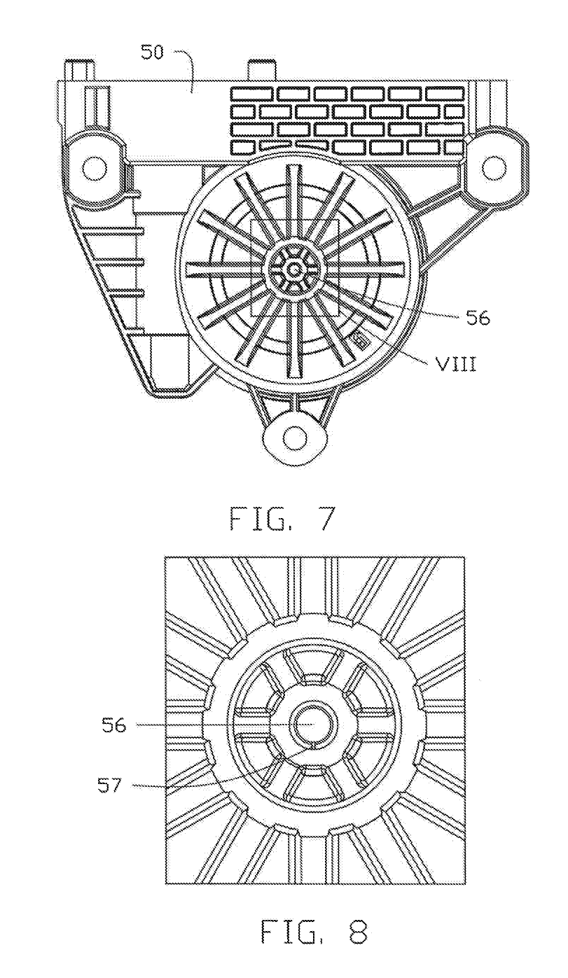

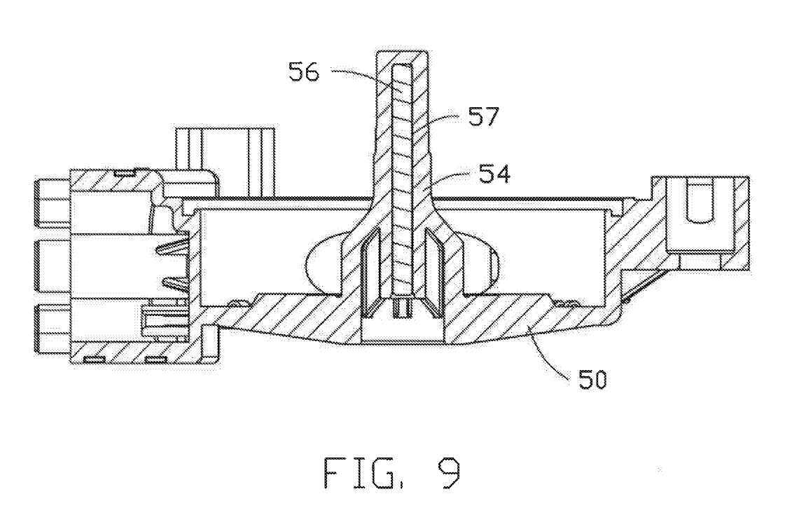

FIG. 6 through FIG. 9 illustrate a lower housing 50 of a gearbox of a drive apparatus in accordance with a second embodiment of the present invention. The core shaft 58 of this embodiment has a smooth outer surface. That is, the knurls of the first embodiment are removed from the core shaft 58. In order to prevent the air from being trapped at the top end of the center hole 56 during the course of inserting the core shaft 58 into the support shaft 54, a ventilation groove 57 is defined in a peripheral edge of the center hole 56 of the present embodiment. The ventilation groove 57 is in communication with the center hole 56 and extends along an extension direction of the center hole 56. Preferably, the length of the ventilation groove 57 and the length of the center hole 56 are substantially the same. A ratio of a width of an opening of the ventilation groove where the center hole is connected and a diameter of the center hole ranges from 0.1 to 0.5. The ventilation groove 57 may be formed conveniently during the injection molding of the lower housing 50. Because of the ventilation groove 57, the knurls are omitted from the core shaft 58, which eliminates the knurling process of the core shaft 58, thereby further reducing the cost and simplifying the fabrication process.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

For example, a non-standard cylindrical center hole such as a polygonal hole, e.g. a square hole or a hexagonal hole, is formed to replace the ventilation groove; or, the center hole is slightly tapered along the axial direction of the support shaft.

1. An actuator gearbox comprising:
a lower housing comprising a bottom end, an opened top end, and a support shaft extending up from the bottom end, the support shaft being hollow and made of a plastic material;
a gear received in the lower housing and supported by the support shaft for rotation relative to the lower housing;
a cover disposed at the top end of the lower housing, the support shaft extending through the cover out of the lower housing; and
a core shaft inserted into the support shaft, the core shaft being made of a metal material.

2. The gearbox of claim 1, wherein the support shaft and the lower housing are integrally formed by injection molding.

3. The gearbox of claim 1, wherein a center hole is formed in the support shaft, and the core shaft is an interference-fit in the center hole of the support shaft.

4. The gearbox of claim 3, wherein the center hole is a blind hole with one end closed and the other end opened.

5. The gearbox of claim 3, wherein at least a portion of an outer surface of the core shaft and an inner wall surface of the center hole form a gap there between.

6. The gearbox of claim 5, wherein the center hole is a round hole, and said portion of the outer surface of the core shaft is formed with knurls.

7. The gearbox of claim 5, wherein the gap between the core shaft and the center hole is formed by a ventilation groove extending axially along the inner wall surface of the center hole.

8. The gearbox of claim 7, wherein a ratio of a width of an opening of the ventilation groove in the center hole and a diameter of the center hole ranges from 0.1 to 0.5.

9. The gearbox of claim 1, wherein the core shaft is made of steel.

10. The gearbox of claim 1, wherein a ratio of a largest diameter of the core shaft to a smallest diameter of the support shaft ranges from 0.1 to 0.75.

11. An actuator comprising:
a motor; and
a gearbox connected with the motor, the gearbox comprising:
a lower housing comprising a bottom end, an opened top end, and a support shaft extending up from the bottom end, the support shaft being hollow and made of a plastic material;
a gear received in the lower housing and supported on the support shaft for rotation relative to the lower housing;
a cover disposed at the top end of the lower housing, the support shaft extending through the cover out of the lower housing; and
a core shaft inserted into the support shaft, the core shaft being made of a metal material.

12. The actuator of claim 11, wherein the gear is a worm gear driven by a worm formed on a shaft of the motor.

13. The actuator of claim 11, wherein a center hole is formed in the support shaft, and the core shaft is an interference-fit in the center hole of the support shaft.

14. The actuator of claim 13, wherein the center hole is a blind hole with one end closed and the other end opened.

15. The actuator of claim 13, wherein at least a portion of an outer surface of the core shaft and an inner wall surface of the center hole form a gap there between.

16. The actuator of claim 15, wherein the center hole is a round hole, and said portion of the outer surface of the core shaft is formed with knurls.

17. The actuator of claim 15, wherein the gap between the core shaft and the center hole is formed by a ventilation groove extending axially along the inner wall surface of the center hole.

18. The actuator of claim 17, wherein a ratio of a width of an opening of the ventilation groove in the center hole and a diameter of the center hole ranges from 0.1 to 0.5.

19. The actuator of claim 11, wherein a ratio of a largest diameter of the core shaft to a smallest diameter of the support shaft ranges from 0.1 to 0.75.
